(19) United States
(12) Patent Application Publication
(10) Pub. No.: US 2004/0194513 A1
(43) Pub. Date: Oct. 7, 2004

(54) Fiber coolant system including improved gas seals

(76) Inventors: Frederick W. Giacobbe, Naperville, IL (US); Ovidiu Marin, St. Cloud (FR); Joseph E. Paganessi, Burr Ridge, IL (US); M. Usman Ghani, Bolingbrook, IL (US); Martin Theriault, Sunny Isles Beach, FL (US)

Correspondence Address: LINDA K. RUSSELL, AIR LIQUIDE, SUITE 1800, 2700 POST OAK BLVD, HOUSTON, TX, 77070, US

(21) Appl. No.: 10/765,468

(22) Filed: Jan. 28, 2004

Related U.S. Application Data
(60) Provisional application No. 60/460,673, filed on Apr. 4, 2003.
(60) Provisional application No. 60/464,191, filed on Apr. 21, 2003.

(51) Int. Cl. C03B 37/07

(52) U.S. Cl. 65/512; 65/513; 65/514; 65/434; 65/377; 65/484

(57) ABSTRACT

A coolant system for cooling a fiber includes a heat exchanger with an internal passage disposed between a fiber inlet and fiber outlet to cool the fiber moving through the internal passage. A plurality of chambers are disposed within the internal passage, and at least one fluid medium flows within at least a portion of the internal passage, and at least one adjustable seal is positioned within the internal passage to form a partition between two adjacent chambers. A gas analyzer communicates with at least one chamber of the internal passage to extract a fluid sample from the chamber and to measure a concentration of a gas in the extracted fluid sample. A controller communicates with the analyzer and controls at least one of the adjustable seal and the flow rate of fluid medium within the internal passage based upon the measured concentration.

### CROSS-REFERENCE TO RELATED APPLICATIONS

This application claims priority from U.S. Provisional Patent Application Serial No. 60/460,673, entitled “Method of Cooling Optical Fibers and Re-circulating Coolant Gases”, and filed Apr. 4, 2003, and U.S. Provisional Patent Application Serial No. 60/464,191, entitled “Gas Seal Device and Process”, and filed Apr. 21, 2003. The disclosures of these provisional patent applications are incorporated herein by reference in their entireties.

### BACKGROUND OF INVENTION

1. Field of Invention

The present invention pertains to coolant chambers employing a coolant gas to cool fibers, in particular optical fibers, moving through the coolant chambers.

2. Related Art

Optical fibers are typically formed by a process in which hot fibers are drawn from the end of a massive cylindrical silica or glass perform that has been heated up to its softening point in a drawing furnace. This drawing process is followed by cooling the fibers within a coolant chamber or heat exchanger utilizing a coolant gas that flows through the heat exchanger in a co-current or countercurrent direction with respect to the velocity vector of the fiber traveling through the exchanger. The drawn fibers must be cooled to a sufficient temperature within the heat exchanger prior to cladding the fiber with a heat sensitive protective coating. Drawing speeds for optical fibers are presently at 20 meters per second and increasing. Thus, the need exists to rapidly and effectively cool hot drawn optical fibers while minimizing the height or length of the heat exchanger and thus the residence time of the fibers within the exchanger.

Utilizing relatively pure helium as the coolant gas provides the safest and most efficient gaseous heat exchange agent for cooling the hot drawn fibers at the desired rate and to the desired temperatures within the heat exchanger. However, there are some problems associated with utilizing helium. One problem relates to the escape and excessive loss of helium through the inlet and outlet ends of the heat exchanger into the surrounding atmosphere during cooling of the fiber. Keeping the loss of helium and/or other coolant gases from the heat exchanger to a minimum during operation is highly desirable to maximize cooling efficiencies within the chamber and minimize operating costs.

Another problem relates to minimizing the amount of air that may be drawn in from the surrounding atmosphere and thus mix with the flowing helium within the heat exchanger. For example, air entrained with the moving fiber can enter through the fiber inlet end of the exchanger. Air can also be drawn from the surrounding atmosphere into the fiber outlet end of the exchanger and travel upward with the helium gas flowing within the exchanger as a result of a “chimney effect”. The “chimney effect” is particularly prevalent when inlet helium flow rates into the heat exchanger are very low (e.g., below a predetermined threshold value).

The entry of air into the central cooling section of the heat exchanger has a detrimental effect on the cooling process in that it can significantly alter the cooling rate of the fiber moving through the heat exchanger due to the poor heat transfer characteristics of helium/air mixtures versus substantially pure helium. In order to reduce the amount of entrained air entering the heat exchanger, certain exchangers employ adjustable seals at either (or both) the fiber inlet and outlet ends of the exchanger. Examples of such heat exchangers for optical fibers are described in U.S. Pat. No. 4,514,205 (Darcangelo et al.) and U.S. Pat. No. 5,377,491 (Schulte). The heat exchangers of Darcangelo et al. and Schulte further provide a fluid seal or gas lock disposed at one or both ends of the heat exchanger to increase the recovery of coolant gas and/or decrease infiltration of contaminants into the exchanger. However, neither Darcangelo et al. nor Schulte describes a system that is capable of automatically controlling certain operating parameters within the system (e.g., coolant gas flow, degree at which the adjustable seals are open or closed, etc.) in the event an undesired flow of air occurs within the coolant chamber.

### SUMMARY OF THE INVENTION

Accordingly, it is an object of the present invention to provide a coolant system for a fiber that effectively maintains cooling of the fiber at one or more desired cooling rates.

It is another object of the present invention to provide a coolant system that substantially minimizes or eliminates the flow of air into the cooling chamber of the system during operation when a fiber is traveling through the coolant system.

It is a further object of the present invention to provide a coolant system that is capable of automatically controlling a variety of system parameters (e.g., the degree of sealing of cavities or chambers of the system, the flow of coolant and/or other gases into the system, etc.) based upon the amount of air that enters into the coolant system.

The aforesaid objects are achieved individually and/or in combination, and it is not intended that the present invention be construed as requiring two or more of the objects to be combined unless expressly required by the claims attached hereto.

In accordance with the present invention, a coolant system for cooling a fiber includes a heat exchanger with an internal passage disposed between a fiber inlet and fiber outlet to cool the fiber moving through the internal passage. A plurality of chambers are disposed within the internal passage, and at least one fluid medium flows within at least a portion of the internal passage, and at least one adjustable seal is positioned within the internal passage to form a partition between two adjacent chambers. A gas analyzer communicates with at least one chamber of the internal passage to extract a fluid sample from the chamber and to measure a concentration of a gas in the extracted fluid sample. A controller communicates with the analyzer and controls at least one of the adjustable seal and the flow rate of fluid medium within the internal passage based upon the measured concentration.

In one embodiment, the internal passage of the heat exchanger includes at least first and second adjustable seals that partition the internal passage into a first chamber, a second chamber, and a primary cooling chamber. The first chamber includes an inlet port to receive a first fluid medium, the second chamber is disposed between the first chamber and the primary cooling chamber and includes an inlet port to receive a second fluid medium. The controller is in communication with the adjustable seals to independently effect opening and closing of the seal orifices to selected dimensions during system operation. The first fluid medium can be the same or different than the second fluid medium.

In addition, the internal passage of the heat exchanger may include at least two adjustable seals to further partition the internal passage into a third chamber and a fourth chamber. The fourth chamber includes an inlet port to receive the first fluid medium, and the third chamber is disposed between the fourth chamber and the primary cooling chamber and includes an inlet port to receive the second fluid medium. The controller is in communication with the two adjustable seals that partition the internal chamber into the third and fourth chambers to independently effect opening and closing of the seal orifices to selected dimensions during system operation. The third chamber further includes an outlet port that is in fluid communication with a recycle inlet port of the second chamber via a recycle line, and the controller is configured to communicate with a pump disposed along the recycle line to facilitate recycling of the second fluid medium from the third chamber into the second chamber at a selected flow rate.

In yet another embodiment, a coolant system includes a plurality of heat exchangers in fluid communication with each other to facilitate independent cooling of the fiber at different cooling rates as the fiber passes through each heat exchanger.

The above and still further objects, features and advantages of the present invention will become apparent upon consideration of the following detailed description of specific embodiments thereof, particularly when taken in conjunction with the accompanying drawings wherein like reference numerals in the figures are utilized to designate like components.

### BRIEF DESCRIPTION OF THE DRAWINGS

FIG. 1 is a schematic view of a heat exchanger for use in a fiber coolant system in accordance with the present invention.

FIG. 2 is a schematic view of a fiber coolant system in accordance with the present invention.

FIG. 3 is a schematic view of a fiber coolant system employing a series of heat exchangers in accordance with the present invention.

### DESCRIPTION OF PREFERRED EMBODIMENTS

The fiber coolant system of the present invention provides effective cooling of fibers at one or more desired cooling rates during system operation while minimizing or eliminating the flow of air into the system as a result of selectively controlling adjustable seals at one or more locations of the coolant system and/or controlling the flow rate of various fluid mediums within the heat exchanger. Gas concentrations are analyzed at selected locations within the system during fiber cooling, and one or more system parameters can be automatically adjusted based upon the measured gas concentration, thus ensuring the desired cooling rate or rates are achieved during system operation. The fiber coolant system combines a heat exchanger configured to receive a continuously moving fiber (e.g., an optical fiber formed from silica or glass), a pump to recirculate coolant gas flowing through the heat exchanger for cooling the fiber, a gas analyzer to selectively analyze gaseous concentrations at selected locations within the heat exchanger, and a controller to selectively control one or more adjustable seals and/or gas flow rates within the heat exchanger as described below.

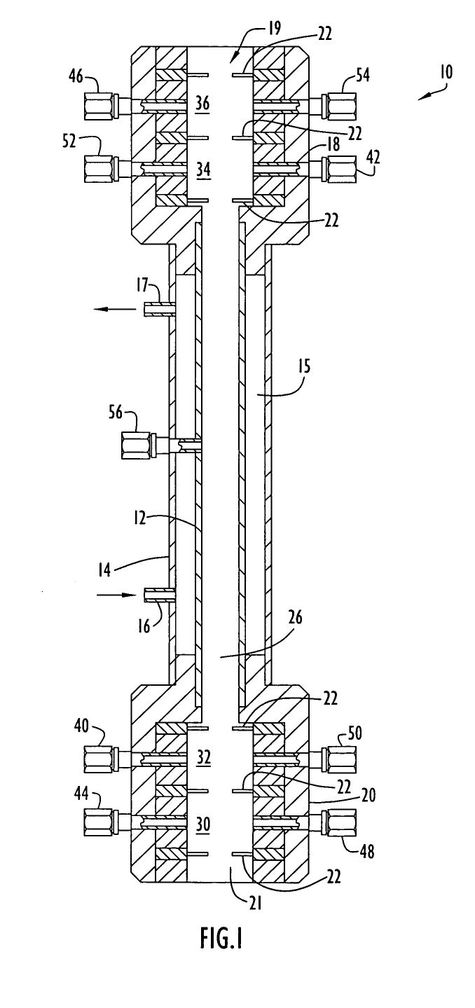

An exemplary heat exchanger for use with the system of the present invention is illustrated in FIG. 1. Heat exchanger 10 is formed with a hollow central tube section 12 (e.g., formed from copper or any other suitable materials) disposed and aligned coaxially within a hollow outer tube section 14 (e.g., formed from stainless steel or any other suitable materials) having a larger cross-sectional dimension than the central tube section so as to form an annular gap 15 between the two sections. An inlet conduit 16 and an outlet conduit 17 extend transversely from the outer tube section 14 at axially separated locations from each other near the ends of the outer tube section to facilitate the flow of a fluid medium through the outer tube section when the conduits are connected to a fluid medium supply source. The outer tube section 14 serves as a cooling jacket for the central tube section 12 during system operation. The fluid medium flowing through the outer tube section can be water or any other suitable gas or liquid medium (e.g., liquid nitrogen) capable of cooling the contents flowing within the central tube section 12 to within a suitable temperature range. Alternatively, the fluid medium may be heated to a selected temperature to prevent rapid cooling of the fiber in the heat exchanger. Basically, any fluids at any desired temperatures (e.g., heated or cooled water, liquid or gaseous hydrocarbons or hydrocarbon mixtures, heated oils, etc.) may be provided within the outer tube section that facilitate precise control of the cooling rate of the fiber traveling through the heat exchanger.

End closures 18 and 20 (e.g., formed from aluminum or any other suitable materials) are secured at the terminal ends of the central and outer tube sections. The end closures 18 and 20 provide a fluid tight seal at the terminal ends of the outer tube section 14 such that the annular gap 15 defines a sealed chamber between the central and outer tube sections. Each end closure 18, 20 includes a hollow central portion that communicates with the hollow central tube section 12, and the heat exchanger is aligned in a generally vertical orientation within the fiber coolant system so as to permit a fiber to extend through the axial flow passage defined by the hollow portions of the end closures and the central tube section. As depicted in FIG. 1, the upper end closure 18 provides a fiber inlet 19 at its terminal end to permit entry of the moving fiber into the heat exchanger, while lower end closure 20 provides a fiber outlet 21 at its terminal end to permit exit of the moving fiber from the heat exchanger.

Each end closure is further partitioned into two or more chambers by at least one adjustable seal. An “adjustable seal”, as used herein, refers to any suitable mechanical seal device disposed at an end of a chamber or between adjacent chambers and that includes a variable orifice having dimensions that are adjustable by manipulation of the mechanical seal. One example of an adjustable seal is an iris diaphragm that includes a series of sliding plates (e.g., 16 or more plates) that combine to form a generally circular orifice and are selectively manipulated to increase and/or decrease the diameter of the orifice. Iris diaphragms suitable for use with the heat exchanger include those commercially available from Edmund Scientific (e.g., Model No. H53-912, with minimum/maximum variable orifice diameters of 1.2 mm/37.0 mm).

Another example of an adjustable seal includes at least two plates that include complimentary cut-out sections (e.g., cut-out sections with geometric configurations such as V-shaped, rectangular, concave, etc.), and the plates are manipulated to overlap each other in a sliding manner so as to form a variable orifice of a selected geometric configuration and selected dimensions. The use of one type of adjustable seal in relation to another will depend upon a particular scenario. For example, in certain situations, it may be desirable to utilize an iris diaphragm so as to provide a variable orifice of substantially uniform circular configuration. In other scenarios, particularly when employing a “clam-shell” exchanger embodiment (i.e., a heat exchanger that separates along its axial dimension into two or more hinged sections), it may be desirable to utilize an adjustable seal with two or more sliding plates (e.g., two plates with V-shaped cut-out portions), where at least one plate is oriented on one portion of the “clam-shell” exchanger to facilitate easy opening and closing of the exchanger.

Any selected number of adjustable seals may be utilized within the end closures and/or any other portions of the heat exchanger to selectively partition the internal or fiber flow passage through the heat exchanger into any selected number of chambers. In the embodiment of FIG. 1, each of the upper and lower end closures 18, 20 includes two chambers that are generally uniform in volume and are partitioned by a series of three adjustable seals 22 (e.g., iris diaphragms). Specifically, adjustable seals 22 are disposed proximate the fiber inlet and outlet ends 19, 21 of the end closures 18, 20, adjustable seals 22 are disposed proximate the ends of the end closures 18, 20 that are adjacent the central tube section 12, and an adjustable seal 22 is disposed in a generally central portion of each end closure 18, 20. The seals 22 extend from the inner side walls of the end closures at their respective locations such that the variable orifices are aligned to correspond with the central axis of the heat exchanger, thus allowing a fiber to extend through the variable orifices of the seals as the fiber travels through the heat exchanger.

The lower end enclosure 20 includes a first chamber 30 adjacent the fiber outlet 21 and a second chamber 32 disposed between the first chamber 30 and an intermediate or primary cooling chamber 26 defined by the interior of the central tube section 12. The upper end enclosure 22 includes a third chamber 34 disposed between a fourth chamber 36 and the intermediate chamber 26, where the fourth chamber 36 is adjacent the fiber inlet 19. The second chamber 32 includes an inlet port 40 that is configured to connect with a coolant gas supply source (e.g., a tank or vessel), via suitable compression and/or other fittings, to facilitate injection of a coolant gas into the heat exchanger 10. The third chamber 34 includes an outlet port 42 to facilitate the exit of coolant gas from the heat exchanger upon traveling through the intermediate chamber 26. Each of the first and fourth chambers 30,36 includes an inlet port 44, 46 that connects with a sealing gas supply source (e.g., a tank or vessel) to facilitate injection of a sealing gas into these chambers as described below.

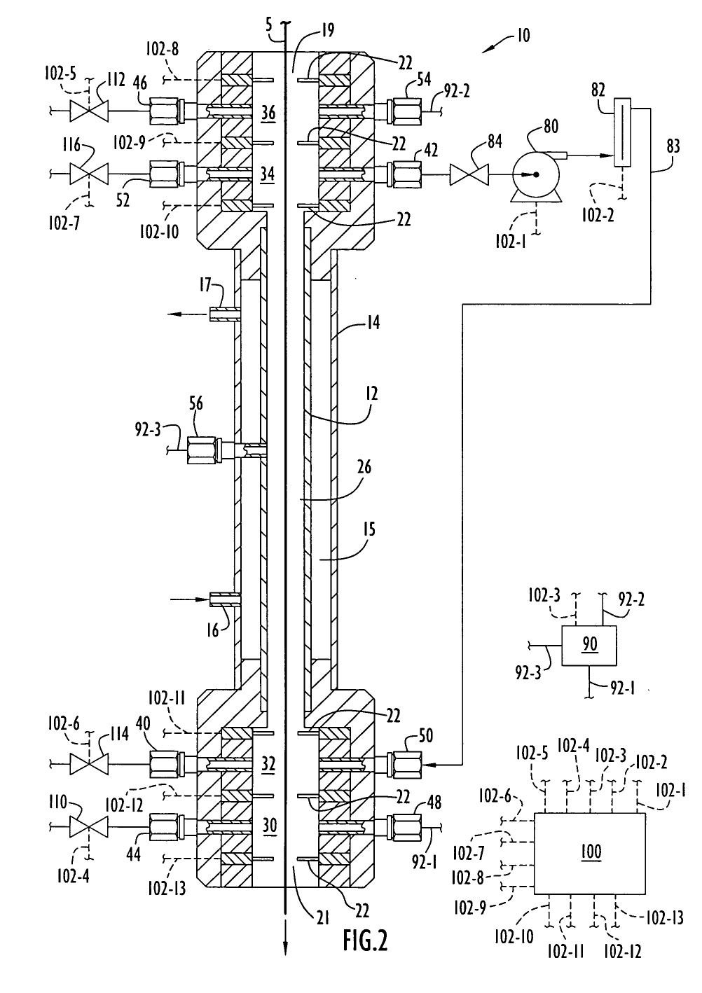

Each of the first, second, third and fourth chambers 30, 32, 34 and 36 further includes a sample extraction port 48, 50, 52, 54 that is configured to connect with a gas analyzer to facilitate extraction of a gas sample from each chamber for analysis by a gas analyzer. Alternatively, or in addition to securing to a gas analyzer, port 50 of the second chamber 32 may be connected with port 42 of the third chamber 34 via a recycle line. A recycle pump can be disposed in the recycle line (as described below and depicted in FIG. 2) to facilitate recycling of the coolant gas from the outlet port 42 of the third chamber 34 back into the inlet port 50 of the second chamber 32. In addition, port 52 of the third chamber 34 may be secured to the gas coolant supply source, as an alternative or in addition to being secured to the gas analyzer, so as to provide an auxiliary inlet for coolant gas flow into the heat exchanger. The intermediate chamber 26 also includes a port 56 that may serve as an additional inlet for coolant gas and/or a sample port for extraction of a sample from the intermediate chamber for delivery and analysis at the gas analyzer.

In operation, a coolant gas is delivered from a coolant supply source into the second chamber 32 (via port 40 and/or port 50), through the intermediate chamber 26, and through the third chamber 34, where it exits through port 42. The coolant gas may be any one or combination of suitable cooling gases including, without limitation, helium, neon, argon, krypton, xenon, hydrogen, nitrogen, and carbon dioxide. As noted above, helium is a preferred coolant gas for cooling optical fibers. However, certain combinations of coolant gases, such as a combination of substantially pure helium and substantially pure hydrogen, are useful in that they can provide a certain “fine tuning” or more precise control of the cooling rate of the fiber in the heat exchanger due to the modification in the overall heat transfer coefficient that occurs by combination of different gas mixtures and/or gas purity levels.

Optionally, the coolant gas or coolant gas mixtures further include one or more gas dopants that are capable of modifying the structural and/or chemical properties of the surface of the fiber in a desirable and beneficial manner when the coolant gas contacts the fiber within the second, third and/or intermediate chambers 32, 34 and 26. Exemplary dopants include, without limitation, silanes, phosphines, fluorine, chlorine, gaseous organometallic compounds, and combinations thereof.

During initial system start-up, when a fiber is being guided through the heat exchanger, the variable orifices of the adjustable seals 22 may be fully opened to provide the largest possible gap between the seals and the fiber. After the fiber has been guided through the heat exchanger and is emerging from the fiber outlet 21 of the exchanger 10, the seals 22 can be selectively adjusted to effect enclosure and isolation of different chambers during system operation to substantially minimize or prevent the flow of air from entering through either or both the fiber inlet 19 and outlet 21 as well as prevent coolant gas from escaping from the exchanger 10.

Optionally, a sealing gas may also be delivered into either or both the first and fourth chambers 30 and 36 to achieve a tighter seal of the second, intermediate and third chambers 32, 26 and 34 and further prevent coolant gas leaks from the heat exchanger as well as the minimization or prevention of air from infiltrating the intermediate chamber 26 where much of the fiber cooling process occurs. The sealing gas may the same or different than the cooling gas. Exemplary sealing gases include, without limitation, any one or combination of gases: helium, neon, argon, krypton, xenon, hydrogen, nitrogen, and carbon dioxide. Preferred sealing gases or sealing gas combinations are nitrogen, argon, carbon dioxide, and argon/carbon dioxide mixtures.

Optionally, the sealing gas or gases may be doped with an impurity that is easily detectable and measurable. Providing an easily measurable dopant in the sealing gas is useful in certain situations where the sealing gas may be difficult to detect alone. For example, when utilizing argon as a sealing gas in the first and/or fourth chambers of the heat exchanger, and helium as the coolant gas to cool the fiber traveling through the heat exchanger, it is possible that low concentrations of argon may flow into the second, third and intermediate chambers and thus alter the heat transfer characteristics of the coolant gas. Low concentration levels of argon in helium may be difficult to detect. However, if argon is doped with carbon dioxide, the carbon dioxide will be easy to detect in the presence of helium, which will provide an indication that sealing gas is infiltrating the second, third and/or intermediate sections where cooling of the fiber occurs.

Periodically, the concentration of gases flowing within any one or more of the chambers can be measured by extracting a gas sample through the sample extraction ports 48, 50, 52, 54 to the gas analyzer. The concentration of any one or more gases (e.g., oxygen, helium, nitrogen and/or carbon dioxide) can be measured in any of the chambers to determine the degree to which the coolant gas is escaping from the heat exchanger, air is infiltrating the heat exchanger and/or sealing gas is infiltrating the main cooling portions of the heat exchanger (e.g., the second, third and intermediate chambers). Based upon these measurements, any one or more of the adjustable seals 22 can be manipulated to enlarge or reduce the dimensions of the variable orifice in order to more effectively seal certain chambers and/or allow undesired gases from escaping certain chambers. For example, if a gas sample is analyzed in the second and/or third chambers 32 and 34 and the amount of oxygen measured in the sample is above a threshold value, any one or more of the adjustable seals 22 enclosing the chambers can be manipulated to further close the variable orifice around the fiber traveling through the heat exchanger 10.

Alternatively, or in combination with the manipulation of adjustable seals 22, the flow rate of coolant gas into the second and/or third chambers 32 and 34 and/or the flow rate of sealing gas into the first and/or fourth chambers 30 and 36 can be adjusted to minimize or prevent further infiltration of undesired gases into certain chambers. For example, if a sample gas is extracted in the third chamber 34 and an oxygen concentration measurement is above a threshold value (i.e., indicating that the flow of air into the fiber inlet 19 is too great), one or both adjustable seals 22 bordering the third chamber 34 can be manipulated to reduce the dimensions of the variable orifice for these seals. Alternatively, or in combination with the seal adjustment, the flow rate of sealing gas into the fourth chamber 36 (via inlet port 46) can be increased to further minimize or prevent air from passing through the fourth chamber 36 into the third and intermediate chambers 34 and 26. Further still, coolant gas may be injected into the third chamber 34 (via the inlet port 52) to provide further sealing of the intermediate chamber 26 from the ingress of air. Once the concentration of oxygen is reduced to below the threshold value (e.g., by measuring concentrations of extracted samples from the third and/or intermediate chambers 34 and 36), the flow rates of coolant gas and sealing gas into the third and fourth chambers can be adjusted to appropriate levels as determined for normal system operation.

The control and adjustment of operating parameters such as the variable orifice dimensions of the adjustable seals and the flow rates of coolant and sealing gases can be controlled manually or automatically during system operation. In the coolant system depicted in FIG. 2, automatic control of these operating parameters is achieved utilizing a controller that is in communication with a number of system components as described below. Referring to FIG. 2, a coolant system 1 includes the heat exchanger 10 of FIG. 1, a recycle pump 80, a gas flow analyzer 90 and a controller 100. A coolant fluid recycle line 83 connects the outlet 42 of the third chamber 34 to the inlet 50 of the second chamber 32, with the pump 80 and a flowmeter 82 being disposed in the recycle line 83 to facilitate controlling the flow rate and pressure of recycled coolant gas back into the second chamber 32. Preferably, the recycled coolant gas is maintained at a selected pressure above the ambient surrounding pressure and at a selected flow rate that minimizes or prevents the entrainment of air from the fiber outlet 21 of the heat exchanger 10 due to the “chimney effect” (as described above). A valve 84 is also disposed in the recycle line 83 between the outlet 42 and the pump 80 to selectively control the flow of coolant gas exiting the heat exchanger for delivery to the pump. The recycle line 83 may further include any one or more suitable purification systems to purify the coolant gas prior to injection back into the heat exchanger.

The gas flow analyzer 90 is connected to the port 48, 52 and 56 of each of the first, fourth and intermediate chambers 30, 36 and 26 via a gas extraction line 92-1, 92-2 and 92-3. Optionally, the analyzer may also be connected to one or both of the second and third chambers 32 and 34 in a similar manner as described above for the other chambers to facilitate selective extraction of a sample from each of these chambers. The gas analyzer may be of any suitable type to facilitate the analysis of any one or more gases in an extraction sample to determine the concentration of the selected gas or gases in the sample. In addition, while only one gas analyzer is shown, any selected number of analyzers may be connected with the system to facilitate the measurement of one or more gases at different times or simultaneously in any one or more chambers within the heat exchanger. Two exemplary gas analyzers suitable for use with the system are an oxygen analyzer available from Teledyne Analytical Instruments (Model No. Turbo 2P) and a Maihak infra red carbon dioxide gas analyzer (Model No. Unor 6N).

The inlet ports 44 and 46 to the first and fourth chambers 30 and 36 are connected with a sealing gas supply via suitable fluid lines, and a valve 110, 112 is disposed in each fluid line to control the flow of sealing gas to each chamber. Similarly, the inlet ports 40 and 52 to the second and third chambers 32 and 34 are connected with a coolant gas supply via suitable fluid lines, with a valve 114 and 116 disposed in each fluid line to control the flow of coolant gas into each chamber.

Any conventional or other suitable type of programmable logic controller (PLC) may be utilized with the coolant system that is capable of selectively communicating with and/or controlling the gas analyzer, recycle pump, the adjustable seals and various valves to adjust the flow of sealing gas and/or coolant gas to one or more of the chambers. In the system of FIG. 2, the controller 100 is in communication (e.g., via electrical wiring and/or wireless connections) with each of the following components: the pump 80 (as indicated by dashed line 102-1 in FIG. 2), the flowmeter 82 (as indicated by dashed line 102-2 in FIG. 2), the gas analyzer 90 (as indicated by dashed line 102-3 in FIG. 2), each of the valves 110, 112, 114 and 116 (as indicated by dashed lines 102-4, 102-5, 102-6 and 102-7 in FIG. 2) that control the flow of sealing gas and coolant gas to each of the first, second, third and fourth chambers 30, 32, 34 and 36, and each of the adjustable seals 22 (as indicated by dashed lines 102-8, 102-9, 102-10, 102-11, 102-12 and 102-13 in FIG. 2). Alternatively, it is noted that, rather than utilizing a single controller as depicted in FIG. 2, any suitable number of controllers (e.g., two or more) may be employed, where the controllers may optionally be in communication with each other, to effect control of various system components during system operation. Automatic manipulation and control of the seals 22 and the various valves 110, 112, 114, and 116 can be achieved utilizing any conventional electromechanical or other suitable control mechanism (e.g., automated electromechanical motors and/or pneumatic devices to effect mechanical manipulations of the seals and valves).

The system 1 effectively cools an optical fiber continuously traveling through the heat exchanger 10 utilizing a coolant gas (e.g., helium and/or any combination of gases as described above) while substantially minimizing or preventing the escape of coolant gas from the exchanger as well as the flow of air into the second, third and intermediate chambers 32, 34 and 26 by automatically controlling one or more system components via the controller 100. Specifically, an optical fiber that has been hot drawn (e.g., from a furnace or other suitable drawing device) at a location upstream of the system 1 is directed into the heat exchanger 10 at the fiber inlet 19. The fiber 5 travels through the axial center of the heat exchanger 10, extending through the fourth, third, intermediate, second and first chambers 36, 34, 26, 32 and 31, and finally emerging through the fiber outlet 21. Upon emerging from the fiber outlet 21, the fiber 5 may be subjected to additional processing within the coolant system (e.g., directed through additional heat exchangers) or directed from the coolant system to a cladding or other fiber processing station.

During an initial start-up period, coolant gas is injected from the coolant gas supply source into the second chamber 32 via inlet 40. The coolant gas flows upward into the intermediate chamber 26 and into the third chamber 34, where it exits through outlet 42 and is directed into the recycle line 83 toward pump 80. The pump 80 directs the coolant gas back into the second chamber 32, via inlet 50, at a selected pressure and flow rate. The coolant gas flows around the fiber 5 between the second and third chambers 32 and 34 to effect cooling of the fiber. Simultaneously, a cooling medium (e.g., water) is flowed through the annular gap 15 of the outer tube section 14 at a selected temperature to cool the coolant gas within the intermediate chamber 26.

Once the initial start-up period has lapsed and there is a sufficient amount of recycled coolant gas flowing within the system to maintain the flow rate within a desired range, the flow of coolant gas from the coolant supply source may be automatically reduced or halted by closing the valve 114 a selected degree via controller 100. Preferably, the valve 114 is maintained in a selected open position during steady state operating conditions to ensure an adequate amount of “make-up” coolant gas (e.g., a selected percentage of the recycled gas flowing through the exchanger 10) continuously flows from the coolant gas supply source into the second chamber 32.

The controller 100 periodically determines the flow rate of recycled coolant gas via the flowmeter 82. If at any time the measured flow rate of recycled coolant gas is below a threshold value, the controller 100 effects an opening of valve 114 to increase the flow of “make-up” coolant gas from the supply source so as to re-establish and maintain the flow rate of coolant gas through the exchanger above the threshold value. Thus, the controller automatically maintains an adequate flow of coolant gas through the heat exchanger despite any losses of the coolant gas from the heat exchanger.

During the initial start-up period, the adjustable seals 22 are manipulated by the controller 100 such that the variable orifices of the seals are at suitable dimensions (e.g., at their maximum dimensions) to facilitate easy passage of the fiber 5 through the orifices. Upon establishing that the fiber is continuously traveling through the heat exchanger (i.e., the traveling fiber is emerging from the fiber outlet 21), the controller 100 automatically controls each adjustable seal 22 to effect closing of the variable orifices around the fiber 5 to selected dimensions in order to reduce the space or gap between the seals and the fiber. In addition, the controller 100 effects opening of valves 110 and 112 to facilitate the injection of sealing gas from the sealing gas supply source into each of the first and fourth chambers 30 and 36. The combination of automatically controlling the adjustable seals to close the variable orifices in toward the fiber 5 as well as the injection of sealing gases in the first and fourth chambers 30 and 36 minimizes the potential for air to enter through either the fiber inlet 19 or fiber outlet 21 of the heat exchanger 10, thus ensuring that the purity of the coolant gas is substantially maintained during cooling of the fiber 5.

Periodically, the controller 100 communicates with the gas analyzer 90 to effect an extraction of a gas sample from one or more of the extraction ports 48, 54 and 56 corresponding with the first, fourth and/or intermediate chambers 30, 36 and 26. The one or more gas samples flow to the analyzer 90 as a result of the pressure differential between the chambers and the gas analyzer. Alternatively, a suction pump may also be provided to draw the gas sample from each chamber when the respective extraction port is opened. The analyzer measures the concentration of a gas within the sample (e.g., oxygen, nitrogen, helium and/or carbon dioxide) and provides the measured concentration information to the controller 100.

Based upon the measured concentration information, the controller 100 effects manipulation of at least one of the following: further opening or closing of the variable orifice of at least one of the adjustable seals 22 within one or both of the end closures 18 and 20, further opening or closing of at least one of the valves 110 and 112 to increase or decrease the flow of sealing gas into one or both of the first and fourth chambers 30 and 36, and/or further opening or closing of at least one of the valves 114 and 116 to increase or decrease the flow of coolant gas into one or both of the second and third chambers 32 and 34.

For example, if a gas sample is extracted from the fourth chamber 36 via port 54 and the measured concentration of oxygen and/or carbon dioxide is above a threshold value, the controller can selectively control the adjustable seals 22 at either end of the fourth chamber 36, as well as the seal 22 disposed between the third and intermediate chambers 34 and 26, to further close the variable orifices of the seals so as to provide a tighter seal (i.e., a reduced space or gap) around the fiber 5. Alternatively, or in addition to the manipulation of the seals 22, the controller 100 can effect further opening of the valve 112 to increase the flow rate of sealing gas into the fourth chamber 36 to prevent entrained air from entering into the fourth and third chambers 36 and 34 with the moving fiber 5. Further, the controller can effect opening of the valve 116 to inject a flow of coolant gas directly into the second chamber 34 via port 52 to further minimize or prevent the entrained air from passing into the intermediate chamber 26.

In another example, a gas sample is extracted from the intermediate chamber 26 via port 56. If the measured concentration of oxygen and/or carbon dioxide is above a threshold value, the controller can effect closing of the variable orifice of each adjustable seal 22 to achieve a tighter seal around the fiber 5 between chambers. In addition, the controller can effect selective manipulation of any of the valves 110, 112, 114 and 116 to increase the flow of coolant gas or sealing gas into any of the first, second, third and fourth chambers 30, 32, 34 and 36 as desired in order to reduce the flow of air into the intermediate chamber 26.

Thus, the system 1 provides effective cooling of the fiber 5 by ensuring an adequate flow rate of coolant gas through the heat exchanger 10 and minimizing the flow of entrained air into the various cooling chambers so as to substantially maintain the purity of the coolant gas. The system 1 further minimizes the escape of coolant gas from the heat exchanger 10 by controlling the degree to which the various chambers within the exchanger are sealed around the moving fiber.

The system of the present invention is not limited to utilizing a single heat exchanger with automated control of various system components. Rather, other systems are contemplated which provide separate cooling chambers or zones to cool the traveling fiber at varying cooling rates. For example, any number of heat exchangers may be arranged in series or end-to-end with each other, where each heat exchanger is separately controlled and includes the same or different coolant gases as well as the same or different cooling (or heating) fluids flowing through the outer tube sections of the heat exchangers, to effectively provide different cooling sections or zones in which the fiber may be cooled at a different rate within two or more heat exchangers. Alternatively, a single heat exchanger may be provided with multiple elongated chambers (e.g., similar to the intermediate chamber for the heat exchanger described above and depicted in FIG. 1) disposed in a stacked relationship with respect to each other and separated by one or more chambers (e.g., sealing gas chambers and/or coolant gas flow chambers).

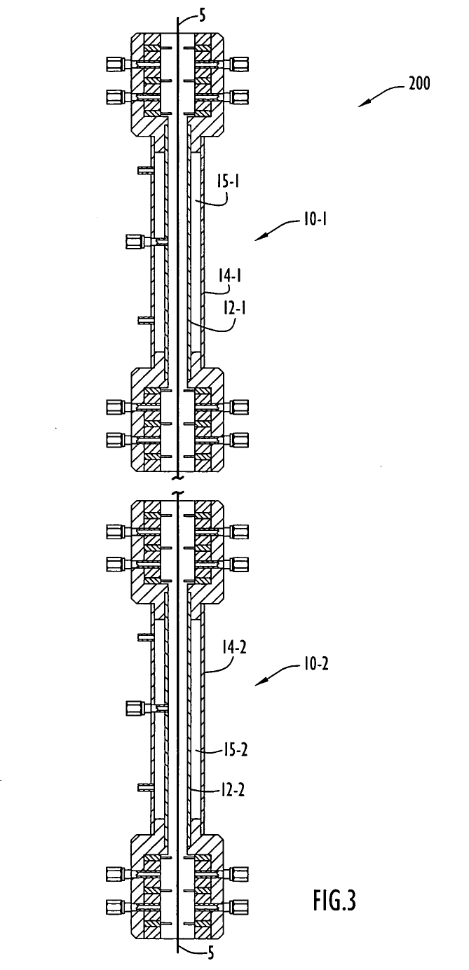

An exemplary system 200 is depicted in FIG. 3 in which a series of heat exchangers 10-1 and 10-2 are arranged in series with respect to each other, where each heat exchanger may include a coolant gas recycle fluid line, gas analyzer and controller to control various system components such as those described above and depicted in FIG. 2. While two heat exchangers are shown in FIG. 3, it is noted that any suitable number (e.g., three or more) of exchangers may be employed. Each heat exchanger may further utilize the same or different coolant gases to achieve a desired cooling rate for the fiber within the particular exchanger. In addition, each heat exchanger may utilize a different fluid medium and/or fluid mediums at different temperatures flowing through the outer tube section to more precisely control the cooling rate within in each exchanger: In an exemplary embodiment, the first heat exchanger 10-1 includes a heated fluid (e.g., hot water or a heated oil) flowing through the annular gap 15-1 formed between the central and outer tube sections 12-1 and 14-1 to inhibit rapid cooling of the fiber within the first exchanger, whereas the second heat exchanger 10-2 includes a fluid medium (e.g., cooled water) flowing in the annular gap 15-2 that is at a different temperature than the fluid flowing in the annular gap 15-1 of the first exchanger 10-1.

Thus, the system 200 provides a series of cooling zones that can be separately and precisely controlled (e.g., manually or automatically), by the combination of coolant gases and cooling (or heating) fluids employed in each heat exchanger, to cool the fiber at varying rates within the system. As noted above, selection of a coolant gas and/or combination of coolant gases, as well as the purity of each coolant gas, will affect the overall heat transfer coefficient of the coolant gas or gas mixture and thus allows one to “fine tune” the cooling rate of the fiber within a particular heat exchanger.

In addition, the heat exchangers may include multiple gas sealing and/or cooling chambers. For example, heat exchangers may include two, three or even more gas sealing chambers disposed within one or both end closures and arranged in a stacked manner, with any selected number of adjustable seals disposed to partition the end closures into the multiple chambers. The additional gas sealing chambers may be provided, for example, for redundancy purposes to ensure that no entrained air can enter the cooling chambers with the moving fiber. Any two or more chambers may include the same or different fluid medium (e.g., gas, liquid or combinations thereof) flowing through the chambers.

Having described novel fiber coolant systems including improved gas seals, it is believed that other modifications, variations and changes will be suggested to those skilled in the art in view of the teachings set forth herein. It is therefore to be understood that all such variations, modifications and changes are believed to fall within the scope of the present invention as defined by the appended claims.

1. A heat exchanger for cooling a fiber moving continuously through the heat exchanger, comprising:
a fiber receiving conduit including a fiber inlet to receive the fiber, a fiber outlet through which the fiber exits the fiber receiving conduit, and an internal passage disposed between the fiber inlet and fiber outlet to cool the fiber moving through the fiber receiving conduit;
wherein the internal passage includes at least two adjustable seals with variable orifices that partition the internal passage into a first chamber, a second chamber, and a primary cooling chamber, the first chamber includes an inlet port to receive a first fluid medium, and the second chamber is disposed between the first chamber and the primary cooling chamber and includes an inlet port to receive a second fluid medium.

2. The heat exchanger of claim 1, further comprising:
an outer conduit disposed around the fiber receiving conduit and defining a chamber between the outer surface of the fiber receiving conduit and the inner surface of the outer conduit, the outer conduit including an inlet port and an outlet port to facilitate a flow of a third fluid medium through the chamber.

3. The heat exchanger of claim 1, further comprising:
at least two adjustable seals to further partition the internal passage into a third chamber and a fourth chamber, wherein the fourth chamber includes an inlet port to receive the first fluid medium, and the third chamber is disposed between the fourth chamber and the primary cooling chamber and includes an inlet port to receive the second fluid medium.

4. The heat exchanger of claim 3, wherein the first and second chambers are disposed proximate the fiber outlet, and the third and fourth chambers are disposed proximate the fiber inlet.

5. The heat exchanger of claim 3, wherein the third chamber includes an outlet port that is in fluid communication with a recycle inlet port of the second chamber via a recycle line to facilitate recycling of the second fluid medium from the third chamber into the second chamber.

6. The heat exchanger of claim 1, wherein at least one of the first, second and primary cooling chambers includes a sample extraction port securable to a gas analyzer to facilitate extraction of fluid samples from the chamber for measuring a concentration of one or more gases in the samples by the gas analyzer.

7. The heat exchanger of claim 1, wherein the first fluid medium is the same as the second fluid medium.

8. The heat exchanger of claim 1, wherein the first fluid medium is different than the second fluid medium.

9. A fiber coolant system comprising:
a heat exchanger comprising a fiber receiving conduit including a fiber inlet to receive the fiber, a fiber outlet through which the fiber exits the fiber receiving conduit, and an internal passage disposed between the fiber inlet and fiber outlet to cool the fiber moving through the fiber receiving conduit, the internal passage including at least one adjustable seal with a variable orifice to partition the internal passage into at least one chamber; and
a controller in communication with the adjustable seal to effect opening and closing of the variable orifice to a selected dimension during system operation.

10. The fiber coolant system of claim 9, further comprising:
an outer conduit disposed around the fiber receiving conduit and defining a chamber between the outer surface of the fiber receiving conduit and the inner surface of the outer conduit, the outer conduit including an inlet port and an outlet port to facilitate a flow of a fluid medium through the chamber.

11. The fiber coolant system of claim 9, wherein the internal passage includes first and second adjustable seals that partition the internal passage into a first chamber, a second chamber, and a primary cooling chamber, the first chamber includes an inlet port to receive a first fluid medium, the second chamber is disposed between the first chamber and the primary cooling chamber and includes an inlet port to receive a second fluid medium, and the controller is in communication with the first and second adjustable seals to independently effect opening and closing of the variable orifices of the first and second adjustable seals to selected dimensions during system operation.

12. The fiber coolant system of claim 11, wherein the internal passage further includes third and fourth adjustable seals to further partition the internal passage into a third chamber and a fourth chamber, wherein the fourth chamber includes an inlet port to receive the first fluid medium, and the third chamber is disposed between the fourth chamber and the primary cooling chamber and includes an inlet port to receive the second fluid medium;
wherein the controller is in communication with the third and fourth adjustable seals to independently effect opening and closing of the variable orifices of the third and fourth adjustable seals to selected dimensions during system operation.

13. The fiber coolant system of claim 12, wherein the third chamber includes an outlet port that is in fluid communication with a recycle inlet port of the second chamber via a recycle line, and the controller is configured to communicate with a pump disposed along the recycle line to facilitate recycling of the second fluid medium from the third chamber into the second chamber at a selected flow rate.

14. The fiber coolant system of claim 11, further comprising a gas analyzer in fluid communication with an extraction port disposed on at least one of the first, second and primary cooling chambers, and the controller communicates with the gas analyzer to facilitate extraction of fluid samples from at least one of the first, second and primary cooling chambers for measuring a concentration of one or more gases in the samples by the gas analyzer.

15. The fiber coolant system of claim 14, wherein the gas analyzer measures the concentration of at least one of oxygen, nitrogen and carbon dioxide in the extracted fluid samples.

16. The fiber coolant system of claim 14, wherein the controller effects opening or closing of the seal orifice of at least one of the first and second adjustable seals when the measured concentration of one or more gases in an extracted fluid sample exceeds a threshold value.

17. The fiber coolant system of claim 14, wherein the controller is configured to independently effect manipulation of a first valve that controls the flow of the first fluid medium to the first chamber and a second valve that controls the flow of the second fluid to the second chamber so as to independently control the flow rates the first fluid medium to the first chamber and the second fluid medium to the second chamber.

18. The fiber coolant system of claim 17, wherein the controller effects manipulation of at least one of the first and second valves when the measured concentration of one or more gases in an extracted fluid sample exceeds a threshold value.

19. The fiber coolant system of claim 11, wherein the first fluid medium is the same as the second fluid medium.

20. The fiber coolant system of claim 11, wherein the first fluid medium is different than the second fluid medium.

21. The fiber coolant system of claim 11, further comprising:
a first fluid medium supply source to deliver the first fluid medium to the inlet port of the first chamber; and
a second fluid medium supply source to deliver the second fluid medium to the inlet port of the second chamber.

22. The fiber coolant system of claim 21, wherein each of the first and second fluid mediums comprises at least one of helium, neon, argon, krypton, xenon, hydrogen, nitrogen, and carbon dioxide.

23. The fiber coolant system of claim 22, wherein the second fluid medium further comprises at least one of a silane, a phosphine, fluorine, chlorine, and gaseous organometallic compounds.

24. The fiber coolant system of claim 9, further comprising:
a plurality of heat exchangers aligned with each other to facilitate travel of the fiber through the heat exchangers and independent cooling of the fiber within each heat exchanger.

25. The fiber coolant system of claim 24, further comprising a plurality of fluid medium supply sources connected to the heat exchangers to supply fluid medium to at least a portion of the internal passage of each heat exchanger, wherein at least two fluid medium supply sources supply a different fluid medium to at least two heat exchangers.

26. The fiber coolant system of claim 24, further comprising:
an outer conduit disposed around the fiber receiving conduit of each heat exchanger and defining a chamber between the outer surface of the fiber receiving conduit and the inner surface of the outer conduit, the outer conduit including an inlet port and an outlet port to facilitate a flow of a fluid medium through the chamber; and
a plurality of fluid medium supply sources to deliver fluid medium to the inlet ports of the outer conduits of the heat exchangers;
wherein at least two fluid medium supply sources deliver fluid medium at a different temperature to the inlet port of the outer conduits of at least two heat exchangers.

27. A fiber coolant system comprising:
a heat exchanger comprising a fiber receiving conduit including a fiber inlet to receive the fiber, a fiber outlet through which the fiber exits the fiber receiving conduit, and an internal passage disposed between the fiber inlet and fiber outlet to cool the fiber moving through the fiber receiving conduit, the internal passage including a plurality of chambers with at least one fluid medium flowing within at least a portion of the internal passage and at least one adjustable seal being positioned within the internal passage to form a partition between two adjacent chambers;
a gas analyzer in fluid communication with at least one chamber of the internal passage to extract a fluid sample from the at least one chamber and measure a concentration of at least one gas in the extracted fluid sample; and
a controller in communication with the gas analyzer and the at least one adjustable seal to effect at least one of an adjustment of a dimension of a variable orifice of the at least one adjustable seal and the flow rate of fluid medium within the internal passage when the measured concentration of the at least one gas in the extracted fluid sample exceeds a threshold value.

28. A method of cooling a fiber in a coolant system, the coolant system including a heat exchanger with a fiber receiving conduit including a fiber inlet, a fiber outlet, and an internal passage disposed between the fiber inlet and fiber outlet, the internal passage including at least one adjustable seal with a variable orifice, and a controller in communication with the adjustable seal, the method comprising:
passing a fiber through the internal passage between the fiber inlet and the fiber outlet; and
manipulating the at least one adjustable seal, via the controller, to selectively adjust a dimension of the seal orifice.

29. The method of claim 28, wherein the heat exchanger further includes an outer conduit disposed around the fiber receiving conduit and defining a chamber between the outer surface of the fiber receiving conduit and the inner surface of the outer conduit, and the method further comprises:
flowing a fluid medium through the chamber between an inlet port and an outlet port of the outer conduit.

30. The method of claim 29, wherein the fluid medium comprises at least one of water, one or more hydrocarbons, a substantially pure gas and a substantially pure liquid.

31. The method of claim 30, wherein the fiber is passed through the internal passage of a plurality of heat exchangers, and the temperature of fluid medium flowing through the chamber of at least one heat exchanger is different than the temperature of fluid medium flowing through the chamber of at least one other heat exchanger.

32. The method of claim 28, wherein the internal passage includes first and second adjustable seals that partition the internal passage into a first chamber, a second chamber, and a primary cooling chamber, the first chamber includes an inlet port, the second chamber is disposed between the first chamber and the primary cooling chamber and includes an inlet port, and the controller is in communication with the first and second adjustable seals, the method further comprising:
flowing a first fluid medium into the first chamber via the inlet port of the first chamber;
flowing a second fluid medium into the second chamber via the inlet port of the second chamber;
wherein the first and second adjustable seals are independently manipulated, via the controller, to selectively adjust a dimension of the orifice of each adjustable seal.

33. The method of claim 32, wherein the first fluid medium is the same as the second fluid medium.

34. The method of claim 32, wherein the first fluid medium is different than the second fluid medium.

35. The method of claim 32, wherein each of the first and second fluid mediums comprises at least one of helium, neon, argon, krypton, xenon, hydrogen, nitrogen, and carbon dioxide.

36. The method of claim 35, wherein the second fluid medium further comprises at least one of a silane, a phosphine, fluorine, chlorine, and gaseous organometallic compounds.

37. The method of claim 32, wherein the second fluid medium comprises one of helium, hydrogen and a mixture of hydrogen and helium.

38. The method of claim 32, wherein the first fluid medium comprises at least one of argon and carbon dioxide.

39. The method of claim 32, wherein the fiber is passed through the internal passage of a plurality of heat exchangers, and the second fluid medium that is flowed into the second chamber of at least one heat exchanger is different than the second fluid medium that flows into the second chamber of at least one other heat exchanger.

40. The method of claim 32, wherein the internal passage further includes third and fourth adjustable seals to further partition the internal passage into a third chamber and a fourth chamber, wherein the fourth chamber includes an inlet port, and the third chamber is disposed between the fourth chamber and the primary cooling chamber and includes an inlet port, and the controller is in communication with the third and fourth adjustable seals, the method further comprising:
flowing the first fluid medium into the fourth chamber via the inlet port of the fourth chamber;
flowing the second fluid medium into the third chamber via the inlet port of the third chamber;
wherein the third and fourth adjustable seals are independently manipulated, via the controller, to selectively adjust a dimension of the orifice of each adjustable seal.

41. The method of claim 40, wherein the third chamber includes an outlet port that is in fluid communication with a recycle inlet port of the second chamber via a recycle line, and the coolant system further includes a pump that is in communication with the controller, and the method further includes:
controlling the pump, via the controller, to recycle the second fluid medium from the third chamber into the second chamber at a selected flow rate.

42. The method of claim 32, wherein the coolant system further comprises a gas analyzer in fluid communication with an extraction port disposed on at least one of the first, second and primary cooling chambers, and the controller is in communication with the gas analyzer, the method further comprising:
extracting a fluid sample from at least one of the first, second and primary cooling chambers; and
measuring a concentration of one or more gases in the extracted fluid sample via the gas analyzer.

43. The method of claim 42, wherein the gas analyzer measures the concentration of at least one of oxygen, nitrogen and carbon dioxide in the extracted fluid sample.

44. The method of claim 42, wherein the controller effects manipulation of at least one of the first and second adjustable seals to adjust the dimension of the orifice associated with the manipulated seal when the measured concentration of one or more gases in an extracted fluid sample exceeds a threshold value.

45. The method of claim 42, further comprising:
automatically manipulating a first valve connected with the inlet port of the first chamber, via the controller, to open or close so as to control the flow rate of the first fluid medium into the first chamber; and
automatically manipulating a second valve connected with the inlet port of the second chamber, via the controller, to open or close so as to control the flow rate of the second fluid medium into the second chamber.

46. The method of claim 45, wherein the controller effects manipulation of at least one of the first and second valves to open or close when the measured concentration of one or more gases in an extracted fluid sample exceeds a threshold value.

47. The method of claim 28, wherein the fiber is an optical fiber.

48. A method of cooling a fiber utilizing a coolant system including a heat exchanger with an internal passage having a plurality of chambers and at least one adjustable seal that forms a partition between two adjacent chambers, a gas analyzer in fluid communication with at least one chamber of the internal passage, and a controller in communication with the gas analyzer and the at least one adjustable seal, the method comprising:
passing a fiber through the internal passage of the heat exchanger;
flowing a fluid medium through at least a portion of the internal passage to contact the fiber passing through the internal passage;
extracting a fluid sample from the at least one chamber via the gas analyzer;
measuring a concentration of at least one gas in the extracted fluid sample via the gas analyzer; and
effecting, via the controller, an adjustment of at least one of a dimension of a variable orifice of the at least one adjustable seal and the flow rate of fluid medium within the internal passage when the measured concentration of the at least one gas in the extracted fluid sample exceeds a threshold value.
